(19) United States
(12) Patent Application Publication
(10) Pub. No.: US 2005/0131780 A1
(43) Pub. Date: Jun. 16, 2005

(54) Computer system for managing accounting data

(76) Inventor: Rudi Princen, Brussels (BE)

Correspondence Address: ACCENTURE, LLP;C/O HOGAN & HARTSON, LLP (IPGROUP), 555 13TH STREET NW, SUITE 600E, WASHINGTON, DC, 20004, US

(21) Appl. No.: 10/486,848

(22) PCT Filed: Aug. 13, 2002
(86) PCT No.: PCT/EP02/09165

(30) Foreign Application Priority Data
Aug. 13, 2001 (EP) 01203072.2

(51) Int. Cl. G06F 17/60

(52) U.S. Cl. 705/30

(57) ABSTRACT

The object of the invention id to provide a computer system for managing accounting data which avoids the aforementioned paper handling for the benefit of the receiver of invoices. The system aims at the automation of the treatment of the invoices, credit notes or delivery notes in view of facilitating the accounts payables accounting process at companies internationally. To this end, the incoming bills or invoices sent by a seller to a buyer need to be converted into electronic bills or invoices in a format compatible with the system so that they are automatically registered, treated, that is matched with accounting codes of the buyer, i.a., those of purchase orders and delivery notes, and if desired routed to the appropriate people within the buyer's company, and/or posted into the ERP system of the latter by the system.

The present invention relates to a computer system for managing accounting data.

Such computer systems are known and used in a majority of accounting departments of companies. Although computers are largely used for accounting purposes, companies still have to cope with the manual treatment of incoming invoices, generally on paper, from their suppliers. The paper invoice is processed as follows:
incoming mail is opened by an employee;
incoming invoices are registered into a log book;
Invoice copies are transported by internal physical mail to the Accounts Payable department which is responsible for the payment of the invoices or to people from Business Units (e.g. purchasing dept.) for approval and assignment of analytical accounting codes. Some companies scan incoming invoices in order to electronically route invoices to the appropriate persons. The paper invoice travels to various geographical locations depending on the workflow;
invoices are matched with purchase orders and delivery notes. Invoice data are manually entered into the Enterprise Resource Planning (ERP) system which matches the data with the purchase order and/or delivery note. Actions are undertaken if there are mismatches; The ERP manages the accounting of the company but possibly also inventories, purchases etc . . . An example of such a system is SAP.
after approval, invoices are then again physically transported to Accounting department for final posting and payment;
business customers (companies) often contact their sellers in case of mismatches and disputes;
sellers often contact business customers to have an idea on bill status.

Moreover, centralised Accounts Payable departments often pay multiple invoices at once per seller. The seller has then to reconcile one incoming amount on his bank statement with multiple open invoices and credit notes for—potentially—multiple legal entities of the business customer.

A drawback of the known computer systems for managing account data is that they still require quite some paper handling.

The object of the invention is to provide a computer system for managing accounting data which avoids the aforementioned paper handling for the benefit of the receiver of invoices. The system aims at the automation of the treatment of the invoices, credit notes or delivery notes in view of facilitating the accounts payables accounting process at companies internationally. To this end, the incoming bills or invoices sent by a seller to a buyer need to be converted into electronic bills or invoices in a format compatible with the system so that they are automatically registered, treated, that is matched with accounting codes of the buyer, i.a. those of purchase orders and delivery notes, and if desired routed to the appropriate people within the buyer's company, and/or posted into the ERP system of the latter by the system.

The data provided to the system by a buyer and a seller can be transported by the Internet, as well as those routed by said system to the buyer and eventually the seller.

Therefore, the invention proposes a computer system for managing accounting data supplied to the system by a seller and by a buyer, said computer system comprises:
first receiving means provided for receiving an accounting data file supplied to the system by a seller via a supplier network;
screening means provided for screening said accounting data file and for recognising within said accounting data file accounting parameters;
second receiving means provided for receiving accounting codes supplied to the system by a buyer and for storing said accounting codes;
reconciliation means provided for receiving reconciliation rules supplied to the system by the buyer, and for assigning, based on said reconciliation rules, at least one of said accounting codes to at least one of said accounting parameters.

Reference will here be made on bills or invoices as accounting data files, but the system can also be used for the treatment of credit notes or delivery notes supplied by a seller.

A seller who will supply the computer system with accounting data files formed by electronic bills or invoices, is asked first to register to the computer system. This means that he needs to inform the system i.a. about product codes and descriptions of products which will be sold, invoice file communication protocol such as web, http, ftp protocols and invoice format such as EDI; TXT, XML formats. This information is used to: configure the receiving means and the screening means of the computer system, according to the invention in such a manner that account parameters of an accounting data file supplied by the registered seller to the system are recognized.

The seller also needs to use a normalised electronic invoice format which is compatible with the computer system according to the invention, in order to enable the system to apply the defined reconciliation rules to the accounting parameters gathered into said normalised electronic invoice. An electronic invoice format which is compatible with the system can be developed individually for a specific seller or general templates of electronic invoices to which different sellers have to conform their data files can be used. Conversion means between different electronic invoice formats can also be provided.

Registered sellers need to be accepted first by the buyer before they can send any electronic invoice. Once a seller is accepted by the buyer, the latter can charge in the computer system from said buyer's ERP, accounting codes corresponding to the considered seller. These accounting codes comprise account codes such as General ledger code which corresponds to accounting legal requirements, analytical account codes which for instance define which cost center or what cost nature is concerned, as well as product codes corresponding to products or services sold by the considered seller. The computer system will automatically link these accounting codes to the seller for example based on his VAT number.

The computer system further allows the buyer to configure reconciliation rules to automate the treatment of an incoming invoice. A reconciliation rule, also called matching rule, establishes a link between accounting parameters of an invoice of a seller and accounting codes of the buyer corresponding to this seller. Such a rule can be based on:
a purchase order (PO) sent by-the buyer to the seller and if possible the corresponding delivery note provided by the seller to the buyer. These documents contain seller's accounting parameters already reconciliated to buyer's accounting codes that can be used for the treatment of the corresponding invoice since the same corresponding elements will be present in said invoice. In case of mismatch between the invoice and a purchase order or delivery note, a dispute management proceeding can be started.
other available ERP data and bill data, that is the aforementioned buyer accounting codes comprising product codes as well as General Ledger and analytical accounting codes. These codes will be linked to the accounting parameters of the invoice, namely the supplier's product codes. For instance, telecommunication services on the invoice such as 0900 numbers, domestic calls, international calls, internet services might get a fixed General ledger accounting code as well as analytical nature code. The telephone numbers on the bill that initiated the calls might be linked to analytical accounting codes based on geographical or business unit criteria.

It is preferred that first accounting data file routing means are provided within the computer system of the invention for routing, based on accounting code(s) assigned by the system to accounting parameter(s) of an accounting data file, said accounting data file towards a station assigned to a user at said buyer's side, said user being entitled to handle said accounting data file. These means need to be configured in order to define a workflow process from the system to the accurate user at the buyer's side. The configuration is based on a number of criteria such as receiving entity at the buyer's side, seller identity, product code, business unit concerned by the invoice at the buyer's side or invoice amounts: These criteria will define which user at said buyer's side will need to review and approve which invoice.

The computer system according to the invention preferably further comprises means enabling said user during the review of an invoice to assign an accounting code to an accounting parameter of the invoice when no accounting code has been previously assigned to said accounting parameter by the system, or to modify an accounting code previously assigned to an accounting parameter of the invoice by the computer system. This enables the user to complete the reconciliation of the accounting parameters of the invoice with the accounting codes of the buyer. It is also possible for the user to define a new reconciliation rule based on the assignation he has performed, and to introduce this rule into the computer system so that said rule will then be applied by the system to similar cases concerning next invoices.

The computer system is also suitably provided with second accounting data file routing means for routing said accounting data file with assigned accounting code towards a memory of a further data processing device located at said buyer's side, in particular once the invoice has been reviewed and approved. The data processing device is in practice the ERP system of the buyer.

It is also suited that the computer system comprises means for converting the format of the accounting data file once it has been reviewed and approved, into a format compatible with said data processing device, that is with the the ERP system of the buyer. This enable the system according to the invention to be used with different ERP systems of different buyers.

The invention will now be described in more details with reference to the drawings illustrating a preferred embodiment of a computer system according to the invention. In the drawings:

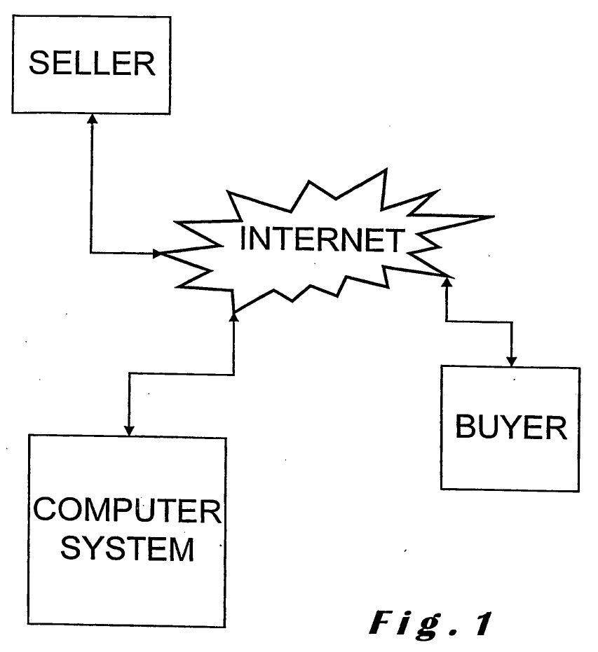

FIG. 1 illustrates schematically the environment wherein the computer system according to the invention operates. The computer system according to the invention and illustrated in FIG. 1 communicates via a supplier network, preferably the internet) with as well the seller as the buyer;

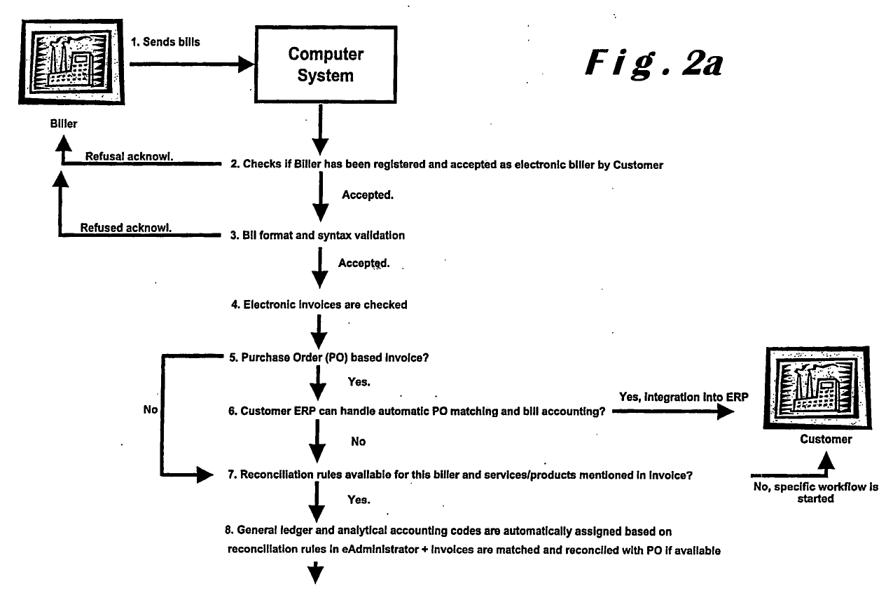

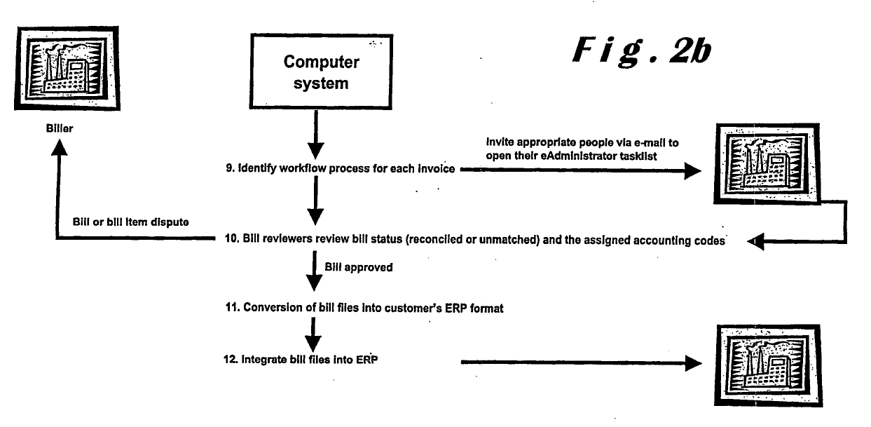

FIG. 2 a+b illustrates, by means of a flow chart, the different steps performed by the computer system according to the invention.

The seller and the buyer communicate with each other via a network, for example the Internet to which the computer system is connected. Referring to FIG. 2 a+b, the following steps are performed:
1. the seller or biller sends an electronic invoice or bill to the computer system or a credit note or delivery note;
2. it is verified if the biller is accepted by the customer. If not the electronic invoice is refused;
3. the format of the bill is verified and checked if in accordance with agreements with the biller;
4. the bill is checked by screening it in order to recognise the accounting parameters of said bill. In addition, check on whether all necessary fields In the invoice are present. If not the invoice is refused and the biller is informed about the error. It is also checked whether products/services on the invoice have been configured in the computer system. If not, the bill is nevertheless accepted but follows a specific workflow because it needs some attention and additional configuration;
5. There is checked if purchase orders and delivery notes are available for this biller. If available, match accounting parameters of the bill with, purchase order data such as amounts, volumes, unit prices and assign the accounting codes to the biller, the whole bill and to each accounting parameter respectively. Reconciliated and non reconciliated bills, i.e. bills whose accounting parameters have respectively been or not been assigned to accounting codes of the buyer, will generally follow a different workflow process, this means non reconciliated bills will be reviewed by other people at the buyer's side;
6. If the ERP of the buyer can handle bills matched with purchase orders and delivery notes automatically, said bills are routed to said ERP.
7. if there are no purchase orders and delivery notes available for the bill, it is reconciliated by means of reconciliation rules defined by the buyer in order to assign general ledger and analytical accounting codes as well as product codes to the accounting parameters of the bill. These parameters are for example:
a) VAT number of biller;
b) VAT number of receiving entity;
c) Person to whom the bill is addressed;
d) Service or product codes mentioned in the invoice e.g. telecommunication services such as 0900, international calls, domestic calls, internet services, etc. to which specific accounting codes.
e) Other data Indicating analytical specifics of the bill, e.g. the electricity meter code or the telephone number that initiated the call. Both can be associated to analytical cost center codes such as a branch, department, business unit.
9. The person or entity in charge of handling the reconciliated bill at the buyer's side is identified based on workflow rules which are based on a number of criteria. These rules define a workflow process according to which the bill is routed to the considered person. The aforementioned criteria are for example:
a) The amount of the bill
b) Purchase order based invoices or not
c) Receiving entity
d) Product/service codes, involved business units
e) The biller
f) Person to whom the bill is addressed
g) Bill status: fully reconciled with Purchase Order, type of mismatch with PO, accounting codes assigned or not, etc.

10. The considered person or entity is notified via e-mail and invited to log into the computer system and have a look at his task list which is composed of the processed bills. Until now no human intervention was needed. The reviewer logs into the computer system and has the ability, based on his access rights and authorisations, to accept or dispute the entire bill or its items. The system allows him in case of a dispute to mention the reason of the dispute and send an e-mail to the appropriate person at the biller side. The computer system will also allow the reviewer to modify the accounting codes, if authorised by his profile, and to refine the accounting and reconciliation rules. Possibly, the bill can be reviewed and or approved by multiple people at the buyer's side.

11.Once the bill is granted all the approvals it needs, the bill is converted again into a format needed by the ERP system.

12.The computer system back office integration tools will integrate the bill into the ERP system.

1 A computer system for managing accounting data supplied to the system by a seller and by a buyer, characterized in that said computer system comprises:
first receiving means provided for receiving an accounting data file supplied to the system by the seller via a supplier network;
screening means provided for screening said accounting data file and for recognizing within said accounting data files accounting parameters;
second receiving means provided for receiving accounting codes supplied to the system by the buyer and for storing said accounting codes; and
reconciliation means provided for receiving reconciliation rules supplied to the system by the buyer, and for assigning, based on said reconciliation rules, at least one of said accounting codes to at least one of said accounting parameters.

2 A computer system according to claim 1, characterized in that it further comprises first accounting data file routing means provided for routing, based on said assigned accounting code, said accounting data file towards a station assigned to a user, at said buyer's side, entitled to handle said accounting data file.

3 A computer system according to claim 2, characterized in that it further comprises means enabling said user to assign one of said accounting codes to one of said accounting parameters when no accounting code has been previously assigned to said accounting parameter by the system or to modify an accounting code previously assigned to said accounting parameter by the computer system.

4 A computer system according to claim 2, characterized in that it further comprises second accounting data file routing means for routing said accounting data file with assigned accounting code towards a memory of a further data processing device located at said buyer's side.

5 A computer system according to claim 4, characterized in that it further comprises means for converting the accounting data file into a format compatible with said data processing device.

6 A computer system for managing accounting data supplied to the system by a seller and by a buyer, characterized in that said computer system comprises:
a first receiving unit for receiving an accounting data file supplied to the system by the seller via a supplier network;
a screening unit for screening said accounting data file and for recognizing, within said accounting data file, accounting parameters;
a second receiving unit for receiving accounting codes supplied to the system by the buyer and for storing said accounting codes; and
a reconciliation unit for receiving reconciliation rules supplied to the system by the buyer, and for assigning, based on said reconciliation rules, at least one of said accounting codes to at least one of said accounting parameters.

7 A computer system according to claim 6, characterized in that it further comprises a first accounting data file routing unit for routing, based on said assigned accounting code, said accounting data file towards a station assigned to a user, at said buyer's side, entitled to handle said accounting data file.

8 A computer system according to claim 7, characterized in that it further comprises an assigning unit for enabling said user to assign one of said accounting codes to one of said accounting parameters when no accounting code has been previously assigned to said accounting parameter by the system or to modify an accounting code previously assigned to said accounting parameter by the computer system.

9 A computer system according to claim 7, characterized in that it further comprises a second accounting data file routing unit for routing said accounting data file with assigned accounting code towards a memory of a further data processing device located at said buyer's side.

10 A computer system according to claim 9, characterized in that it further comprises a converting unit for converting the accounting data file into a format compatible with said data processing device.

11 A method for managing accounting data supplied to a computer system by a seller and by a buyer, comprising:
receiving an accounting data file supplied to the system by the seller via a supplier network;
screening said accounting data file and recognizing, within said accounting data file, accounting parameters;
receiving accounting codes supplied to the system by the buyer and storing said accounting codes; and
receiving reconciliation rules supplied to the system by the buyer, and assigning, based on said reconciliation rules, at least one of said accounting codes to at least one of said accounting parameters.

12 A method according to claim 11, further comprising:
routing, based on said assigned accounting code, said accounting data file towards a station assigned to a user, at said buyer's side, entitled to handle said accounting data file.

13 A method according to claim 12, further comprising:
enabling said user to assign one of said accounting codes to one of said accounting parameters when no accounting code has been previously assigned to said accounting parameter by the system or to modify an accounting code previously assigned to said accounting parameter by the computer system.

14 A method according to claim 12, further comprising:
routing said accounting data file with assigned accounting code towards a memory of a further data processing device located at said buyer's side.

15 A method according to claim 14, further comprising:
converting the accounting data file into a format compatible with said data processing device.
